(19) United States
(12) Patent Application Publication
(10) Pub. No.: US 2024/0421663 A1
(43) Pub. Date: Dec. 19, 2024

(54) SUPER-RATED OPERATION FOR INCREASED WIND TURBINE POWER WITH ENERGY STORAGE

(71) Applicant: University of Virginia Patent Foundation, Charlottesville, VA (US)

(72) Inventors: Carlos C. NOYES, Charlottesville, VA (US); Eric LOTH, Charlottesville, VA (US); Juliet G. SIMPSON, Charlottesville, VA (US)

(73) Assignee: University of Virginia Patent Foundation, Charlottesville, VA (US)

(21) Appl. No.: 18/694,885

(22) PCT Filed: Sep. 23, 2022
(86) PCT No.: PCT/US2022/044620

§ 371 Date: Mar. 22, 2024

Related U.S. Application Data
(60) Provisional application No. 63/248,124, filed on Sep. 24, 2021.
(60) Provisional application No. 63/305,734, filed on Feb. 2, 2022.

(51) Int. Cl. H02K 7/18; H02P 9/02

(52) U.S. Cl. CPC H02K 7/183; H02P 9/02

(57) ABSTRACT

A system for increasing power capture comprising a turbine having a rotor, a generator having a rated power limit, and an energy storage system, wherein the rotor generates a super-rated power above the rated power limit of the generator and the super-rated power is stored in the energy storage system before the generator converts the super-rated power into electric power.

### CROSS-REFERENCE TO RELATED APPLICATIONS

This application is a continuation of U.S. Provisional Application No. 63/248,124 filed on Sep. 24, 2021, and U.S. Provisional Application No. 63/305,734 filed on Feb. 2, 2022, both of which are incorporated herein by reference.

### STATEMENT OF GOVERNMENT INTEREST

This application was made with government support under Grant No. DE AR0000667, awarded by The Department of Energy, and Grant No. 1842490, awarded by the National Science Foundation. The government has certain rights in the application.

### TECHNICAL FIELD

The present disclosure relates to turbine control including wind turbine control for increasing power capture.

### BACKGROUND

The below nomenclature will be utilized to describe wind turbine operation:

| | |
|---|---|
| a | Axial induction factor |
| C_{P} | Power coefficient |
| C_{T} | Thrust coefficient |
| A | Rotor swept area |
| M | Bending moment |
| P | Power |
| Q | Rotor torque |
| T | Rotor thrust |
| U | Wind speed |
| ρ | Air density |
| Ω | Rotor angular velocity |
| Subscripts | |
| ( )_{cut-in} | Cut-in |
| ( )_{cut-out} | Cut-out |
| ( )_{gen} | Generator |
| ( )_{rated} | At rated wind speed |
| ( )ᵣₒₜₒᵣ | Rotor |
| Acronyms | |
| OoP | Out-of-Plane |
| IP | In-Plane |

For conventional wind turbine operation, based on the assumption of a steady incoming wind, the mechanical power extracted by a wind turbine rotor (P) and the downwind thrust force (T) can be defined and related as follows:

$$P = \frac{1}{2} ρ {U}^{3} {C}_{P} A \qquad ( 1 a )$$

$$T = \frac{1}{2} ρ {U}^{2} {C}_{T} A \qquad ( 1 b )$$

$$P = TU ( 1 - a ) \qquad ( 1 c )$$

$$P = Q Ω \qquad ( 1 d )$$

In this expression, C_{P} is the rotor power coefficient, C_{T} is the rotor thrust coefficient, ρ and U are the hub-height incoming air density and wind speed far upstream of the rotor plane, A is swept area of the rotor in the plane normal to this wind, a is the axial induction factor of the rotor, Q is the rotor torque, and Ω is the rotor angular velocity. Rotor power, torque, and thrust can all be related through linear relations as in Eqs. 1c and 1d.

In order to maximize the wind power extracted within turbine design limits, modern variable-speed pitch-controlled wind turbines conventionally operate in four regions based on wind speed, defined as follows:

$$Region 1 P = 0 for U < {U}_{cut - in} \qquad ( 2 a )$$

$$Region 2 P = \frac{1}{2} ρ {U}^{3} {C}_{P} A for {U}_{cut - in} < U < {U}_{rated} \qquad ( 2 b )$$

$$Region 3 P = {P}_{gen} for {U}_{rated} < U < {U}_{cut - out} \qquad ( 2 c )$$

$$Region 4 P = 0 for U > {U}_{cut - out} \qquad ( 2 d )$$

The above four regions are also schematically outlined in FIG. 1. In Region 1 the wind speed is too small (and often too variable in direction) for effective operation, while in Region 4 the wind speed is too high for safe operation. Therefore, P=0 for both Regions 1 and 4. However, the large majority of wind speeds experienced by a wind turbine are between U_{cut-in} and U_{cut-out} in Regions 2 and 3.

In Region 2, the wind turbine ideally operates at optimal design conditions (C_{p,max}) with a tip speed ratio at the optimum value, in order to maximize power extraction. Since this design condition is associated with a constant power coefficient, the power generated by the rotor is proportional to the cube of the incoming wind speed per Eq. 1a. Region 2 ends when the power reaches the maximum power of the generator (P_{gen}), and this associated wind speed is defined as the rated wind speed (U_{rated}). The rated wind speed is traditionally set to be close to, but higher than, the mean wind speed, such that the turbine spends the majority of its time operating in Region 2.

Conventional control in Region 3 is based on nearly constant rotor torque and rotor speed between rated conditions and cut-out conditions. Power production is limited to the rated generator power via blade pitch control, although the available wind energy continues to increase with wind speed. As a result, thrust drops with incoming wind speed in Region 3 as defined in Eq. 3d below. Herein, the subscript “rated” refers to values at the wind turbine rated wind speed. Starting from Eqs. 1a, 1b, 1c, and 3a, a relationship for thrust in Region 3 is derived in Eqs. 3b and 3c seen below, resulting in Eq. 3d. This assumes that power is held constant at P_{rated} for all of Region 3.

$${C}_{p} = {C}_{T} * ( 1 - a ) \qquad ( 3 a )$$

$${C}_{T} = \frac{T}{\frac{1}{2} ρ {U}^{2} A} = \frac{\frac{{P}_{rated}}{U ( 1 - a )}}{\frac{1}{2} ρ {U}^{2} A} = \frac{\frac{1}{2} ρ {AU}_{rated}^{3} {C}_{p , rated}}{\frac{1}{2} ρ {U}^{2} A * U ( 1 - a )} = {( \frac{{U}_{rated}}{U} )}^{3} {C}_{T , rated} \qquad ( 3 b )$$

$$T = \frac{1}{2} ρ {{AU}^{2} ( \frac{{U}_{rated}}{U} )}^{3} {C}_{T , rated} \qquad ( 3 c )$$

$$T = {T}_{rated} ( \frac{{U}_{rated}}{U} ) for {U}_{rated} < U < {U}_{cut - out} \qquad ( 3 d )$$

FIG. 2 provides a graphical depiction of the change in power and thrust with incoming wind speed for all operating wind speeds, with labels for Region 2 (R2) and Region 3 (R3). Additionally, rotor blade structural limits are driven in part by the maximum downwind blade root bending moments, which are proportional to the product of the thrust force and the rotor radius. Since the blade root bending moment is proportional to thrust loads, the bending moment also peaks at rated conditions and decreases in Region 3, as with thrust, as depicted in FIG. 2.

While Region 3 does not capture all available wind energy (as shown in FIG. 2), it is commonly included in modern wind turbine design due to overall balance of energy and cost considerations. In particular, increasing the generator's rated power limit or the rated generator power (and thus rated wind speed) for a given rotor would increase overall annual energy production; however, it would also increase the cost and mass of the generator, which in turn can increase the cost of tower and nacelle housing. In effect, the power is limited by the rated power of a generator. Notably, the generator and nacelle combination are often the most expensive components of a wind turbine, so it is important to optimize the size of the generator and nacelle combination. The high generator and nacelle cost may be partly driven by the large mismatch between typical rotor speed and ideal generator speed, requiring a heavy gearbox in the nacelle or expensive direct-drive generator. Therefore, the rated power (and rated wind speed) is typically optimized for the system to minimize the Levelized Cost of Energy (LCOE), the lifetime costs of a power plant divided by the energy production, given the rotor size and the hub-height wind speed distribution associated with a wind energy site or a wind farm site.

In addition to LCOE considerations, another performance factor for a turbine is the capacity factor, defined as the average annual power normalized by the rated power. Increasing the capacity factor reduces the variability of the energy generation because it provides a more consistent power supply to an electrical grid. Capacity factor can also be considered as a proxy for capacity value to an electrical grid. The capacity factor of wind turbine installations has been increasing in recent years, and increases are expected to continue, particularly for offshore wind farms. In fact, recent prior art turbine designs have focused on low specific power turbines with over-sized rotors to provide this added capacity factor benefit. Such designs effectively increase the amount of time a wind turbine spends operating in Region 3 and therefore help levelize the power produced by wind energy, thereby reducing wind power intermittency.

Aside from increasing capacity factor, adding energy storage is another way to smooth out renewable energy production on an electrical grid. Renewable energy storage can occur in many forms including hydropower, batteries, and compressed air energy storage (CAES). Combined renewable and storage systems may better meet grid demand and provide more levelized output to the grid. Storage and renewable generation may be combined in many ways, including liquid metal battery storage for offshore wind turbines, pumped hydro storage driven by a hydraulic wind turbine, and compressed air energy storage (CAES) with solar energy. Roundtrip efficiencies of 80% or higher are often achieved in current studies for mechanical energy storage systems. However, in all of these cases, the storage system produces less energy to an electrical grid than it received because of efficiency losses. Thus, this energy loss should be considered against potential benefits.

To rectify potential energy loss, various prior art compromise designs have been proposed and utilized. Some such prior art designs allow the turbine to generate slightly more than the rated power in Region 2.5 (the region in the middle of Region 2 that is shown in FIG. 1) to capture some of the turbulent energy fluctuations, with a focus on fluctuations on the 1-minute time scale. Such a proposed system can only capture these energy fluctuations near rated wind speed (Region 2.5) and is subject to efficiency losses in the storage system. Moreover, the rotor thrust increases when capturing these power fluctuations, which will generally require additional structural reinforcement and cost for the rotor and/or tower.

Still others propose the capturing of energy associated with turbulent fluctuations whereby the nominal rated generator speed is increased to capture additional power. This has the benefit of avoiding a storage system and does not require significantly strengthening the rotor or tower. However, such an approach is also predicted to only allow small increases in power efficiencies.

Hence, as can be seen in FIG. 1's Region 3, as the wind speed increases, the power produced by a rotor of the wind turbine remains constant. In effect, the power is limited by the rated power of a generator. Thus, as seen in FIG. 1, the power produced is nominally constant throughout Region 3—the region between rated speed/conditions and cut-out speed/conditions. Thus, there exists a need to increase power production in Region 3 in order to recover a large portion of the available wind energy that is conventionally lost with rated generator limits. Moreover, there is a need to accompany such power production with an energy storage system to increase energy production without increasing the cost and mass of the generator.

### SUMMARY

Different from conventional solutions, the disclosed system and method provide for additional power capture, thereby allowing for larger increases in power production. This additional power capture is achieved via generation of a super-rated power in Region 3, termed Region 3+, and permits the recovery of a large portion of the available wind energy that is conventionally lost with rated generator limits. This system and method of super-rated power generation eliminates the rated power limit in Region 3 (shown in FIG. 1) and generates significantly more power than a conventional turbine based on steady wind principles, while simultaneously accounting for efficiency losses. This increased mechanical power produced and/or generated by the rotor may thereafter be stored in the form of mechanical energy in a mechanical energy storage system, without initially converting the mechanical power to electric power. Thereafter, the stored mechanical energy may be fed into the electric generator when the rotor power production is lower and converted into electric power. In such a manner, the present disclosure's mechanical energy storage system allows for the increased production and/or generation of mechanical power without increasing the electric power that the generator may produce. In effect, the present disclosure removes the generator's constraint on power production by allowing for the production of mechanical power above the rated power limit of the generator.

According to some embodiments consistent with the present disclosure, the proposed system and method describe a super-rated power operation of a turbine or a wind turbine using an integrated energy storage system.

In an aspect of the present disclosure, a system for increasing power capture is disclosed, comprising a turbine having a rotor; a generator having a rated power limit; and an energy storage system; wherein, the rotor may generate super-rated power above the rated power limit of the generator and generated super-rated power may be stored in the energy storage system before the generator converts generated super-rated power into electric power.

In a further aspect, all generated super-rated power is stored in the energy storage system before the generator converts generated super-rated power into electric power.

In a further aspect of the present disclosure, during operation, the rotor has a speed, a pitch, and a torque and the energy storage system may include one or more of a battery storage system, a liquid metal battery storage system, or a mechanical energy storage system.

In yet a further aspect of the present disclosure, the mechanical energy storage system may be at least one of a hydraulic system, a hydraulic accumulator system, a flywheel system, a pumped hydro storage system, or a compressed air energy storage system.

In a further aspect of the disclosure, the system may further comprise a tower, wherein the turbine may be a wind turbine that may be situated on the tower and the generator may be situated at a base of the tower. In some embodiments, the generator may be situated at another location corresponding to the tower.

In yet a further aspect, the hydraulic system may comprise a hydraulic compressor, hydraulic hoses, and a variable hydraulic motor, wherein generated super-rated power may be delivered to the hydraulic compressor which generates hydraulic power that may be transmitted by the hydraulic hoses down to the base of the tower.

In a further aspect, the hydraulic power may be transmitted to the variable hydraulic motor such that the variable hydraulic motor may either create a mechanical energy storage wherein the mechanical energy storage takes the form of compressed fluid energy storage or may convert the hydraulic power into electric power through the generator.

In another aspect of the present disclosure, a wind turbine may comprise a tower with a base, a rotor, a generator having a rated power limit; and an energy storage system; wherein, the wind turbine may be situated on the tower and the generator is situated at the base of the tower.

In a further aspect, the rotor may generate super-rated power above a rated power limit of the generator.

In yet another aspect, generated super-rated power may be stored in the energy storage system before the generator converts the super-rated power into electric power.

In another aspect, a method of controlling a turbine having a rotor may comprise decoupling the rotor from a generator, actuating the rotor to generate super-rated power, wherein generated super-rated power is above a rated power limit of the generator, increasing rotor power until the rotor reaches a set limit and specifically a rated thrust limit, and storing generated super-rated power in an energy storage system.

In a further aspect, decoupling the rotor from the generator may further comprise the use of a hydraulic transmission to decouple the rotor from the generator.

In yet a further aspect, storing generated super-rated power in an energy storage system may further comprise storing generated super-rated power in a hydraulic energy storage system.

In a further aspect, actuating the rotor to generate super rated power may further comprise keeping the rotor speed constant, lowering the rotor pitch, and increasing the rotor torque.

In yet another aspect, storing generated super-rated power in an energy storage system may further comprise storing generated super-rated power in a mechanical energy storage system, a battery energy storage system, or a liquid metal battery energy storage system, or a combination of one or more of a mechanical energy storage system, a battery energy storage system, or a liquid metal battery energy storage system.

In a further aspect, the method may further comprise regenerating generated super-rated power stored in the energy storage system by coupling the energy storage system to the generator, wherein the regenerating step occurs during a period of lower power production.

### BRIEF DESCRIPTION OF THE DRAWINGS

The accompanying drawings, which are incorporated in and constitute a part of this specification, illustrate multiple embodiments of the presently disclosed subject matter and, together with the description, serve to explain the principles of the presently disclosed subject matter; and, furthermore, are not intended in any manner to limit the scope of the presently disclosed subject matter.

FIG. 1 illustrates the four regions of a variable speed pitch-controlled wind turbine.

FIG. 2 illustrates rotor power and thrust for pitch-controlled wind turbines.

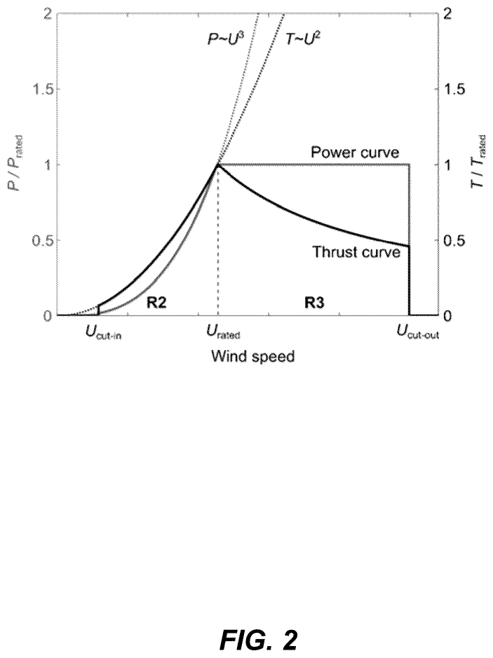

FIG. 3 illustrates a wind turbine of an embodiment of the present disclosure integrated with an energy storage system.

FIG. 4 illustrates a wind energy system of an embodiment of the present disclosure that utilizes a hydraulic system as an energy storage system.

FIG. 5 illustrates a capital expense comparison between an embodiment of a system of the present disclosure and a conventional system.

FIG. 6 illustrates conventional and super-rated curves for power and thrust over operational wind speeds.

FIG. 7 illustrates a wind turbine configuration for various wind turbine systems.

FIG. 8 illustrates wind turbine power production as a function of time for both a conventional system and an embodiment of a system of the present disclosure.

FIG. 9 illustrates a wind turbine power curve for both a conventional system and an embodiment of a system of the present disclosure.

FIG. 10 illustrates a comparison between rotor pitch and wind speed for both a conventional system and an embodiment of a system of the present disclosure.

FIG. 11 illustrates a comparison between power and wind speed for both a conventional system and an embodiment of a system of the present disclosure.

FIG. 12 illustrates wind speed probability distribution functions and correlating power production for both a conventional system and an embodiment of a system of the present disclosure.

FIG. 13 illustrates a method of controlling a turbine according to an embodiment of the present disclosure.

FIG. 14 illustrates a block diagram illustrating an example of a machine upon which one or more aspects of the embodiment of the present disclosure may be implemented.

### DETAILED DESCRIPTION

Reference will now be made in detail to exemplary embodiments, shown in the accompanying drawings.

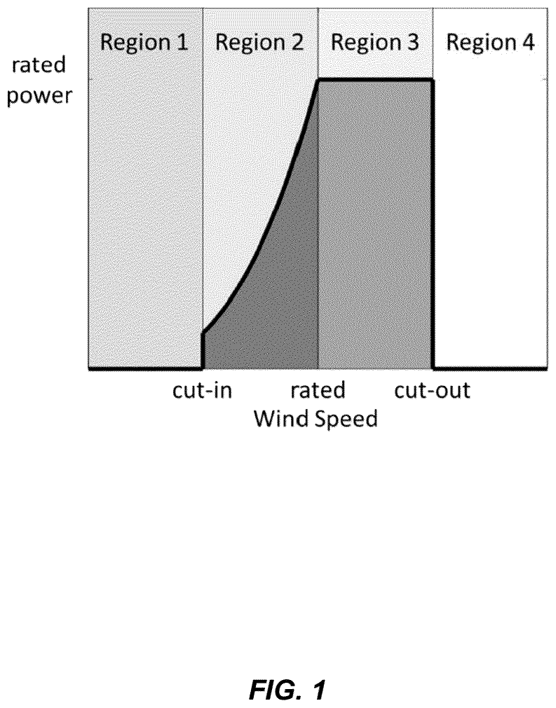

According to some embodiments disclosed herein, a system and method for increasing power capture in a turbine or a wind turbine is detailed. The proposed embodiments disclosed herein solve the need to increase power capture in a turbine or a wind turbine via the use of both an integrated energy storage system and a method and related system of wind turbine operation. This wind turbine operation involves increasing the power produced in a conventional wind turbine, i.e., as depicted in Region 3 of FIG. 1, to a super-rated power in Region 3, termed Region 3+, thereby recovering a large portion of the available wind energy that is conventionally lost with rated generator limits. In this super-rated power operation of the system of the present disclosure, which is integrated with an energy storage system, the turbine or wind turbine may generate super-rated power above the rated power limit of the generator. Thereafter, this generated super-rated power may be stored, compartmentalized, and delivered in any number of ways. For example, a part or a portion of generated super-rated power may be stored in the energy storage system before the generator converts the generated super-rated power into electric power. Alternatively, all generated super-rate may be stored in the energy storage system before the generator converts the generated super-rated power into electric power. Alternatively, still, the generated super-rated power may deliver power to the electric generator at its rated condition or rated power limit and thereafter deliver the surplus power to the energy storage system to the energy storage system. Thereafter, the surplus power may be stored in the energy storage system and thereafter regenerated, when need be, during periods of lower power production. Therefore, wind turbine operation of the embodiments of the present disclosure may drastically increase average power production of conventional systems.

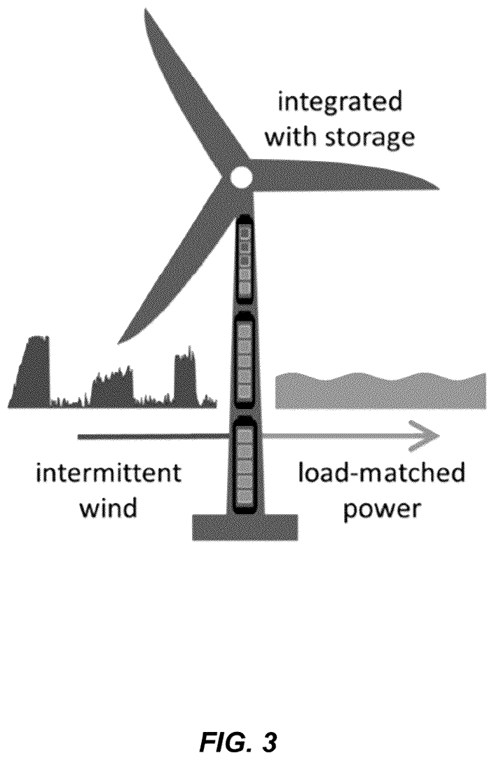

FIG. 3 illustrates a system for a turbine with a rotor or a wind turbine with a rotor integrated with an energy storage system. The integration of the turbine or wind turbine with the energy storage system allows for the power generated intermittently to be delivered to the electrical grid at a nearly constant rate or such that it corresponds to electrical grid demand and/or revenue opportunities. Moreover, such an integration may allow for the storage of surplus power and the regeneration of such stored power when required by demand, making the system of FIG. 3 a dynamic and smart system that may communicate with the electrical gird and provide power as required and demanded. The use of smart systems and sensors to allow for this dynamic communication may be incorporated into the system of FIG. 3. The regeneration of surplus power may also occur specifically during periods of lower power production thereby drastically increasing average power production.

The energy storage system of FIG. 3 may be of various forms including, but not limited to, mechanical energy storage systems, battery storage systems, chemical energy storage systems, and/or liquid metal battery storage systems. The mechanical energy storage systems may in turn further comprise hydraulic systems, hydraulic accumulator systems, flywheel system, hydropower systems, pumped hydro storage systems, fluid storage systems, and/or compressed air energy storage (CAES) systems. As such, the energy storage system of FIG. 3 may encompass a large number of storage systems. The above list is not, in any manner, intended to be limiting. A person of ordinary skill in the art would understand that energy storage systems having various structures and/or functions would apply to the present disclosure.

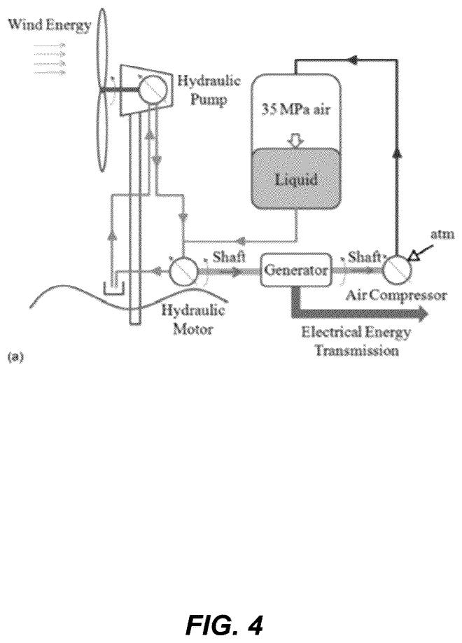

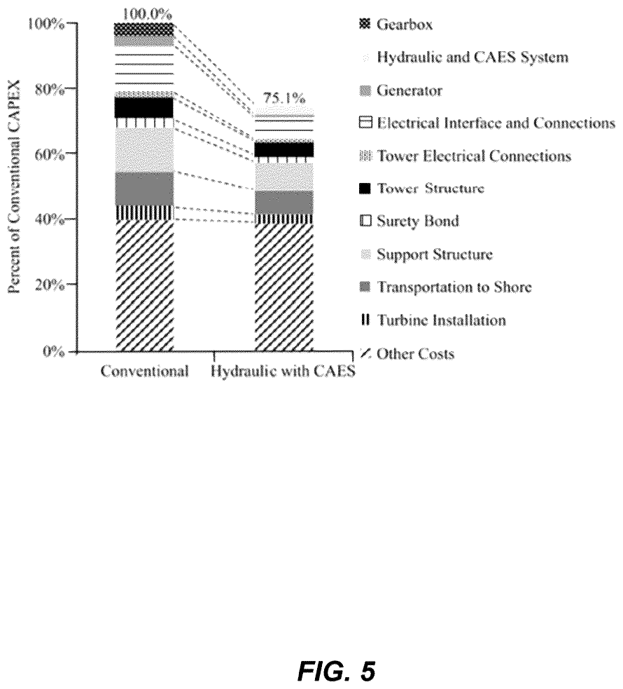

The system of FIG. 4 comprises a turbine having a rotor or a wind turbine having a rotor, a generator having a rated power limit, and an energy storage system wherein the energy storage system is a hydraulic system. As can be seen in FIG. 4, the wind turbine comprises a tower and a base, wherein the wind turbine may be placed and/or situated at the tower. The system of FIG. 4 allows for the decoupling of the wind turbine from the electric generator and the storage of such surplus power in the hydraulic system. The decoupling involves the use of a hydraulic transmission to decouple the wind turbine rotor from the electric generator, thereby permitting mechanical energy storage, such as isothermal compressed air energy storage or fluid energy storage, to be integrated into the wind turbine system before it is transmitted to the electric generator. Herein, as seen in FIG. 4, the rotor power is delivered to the hydraulic compressor or the hydraulic pump which generates hydraulic power that is transmitted by the hydraulic hoses down the tower to the base. The system of FIG. 4 allows the gear box or direct drive hardware to be reduced or eliminated through the use of the hydraulic compressor or the hydraulic pump. Moreover, the system of FIG. 4 allows the generator to be placed and/or situated at the base of the tower and not at the top of the tower with a nacelle, wherein the nacelle is a housing that houses the generating components, gear box, and/or direct drive hardware of the wind turbine. Both these factors, among others, lead to drastically reduced nacelle and tower costs-a major cost reduction in wind turbine construction. Such reduction in capital expense for the construction of FIG. 4's wind turbine system integrated with a hydraulic energy system with compressed air energy storage (CAES) as opposed to a conventional wind turbine system can be seen in FIG. 5, wherein the reduction in cost is almost 25%.

Moreover, at the turbine base of FIG. 4, a variable hydraulic motor may convert the high pressure into electric power with a synchronous generator. Alternatively, the high pressure may be utilized to create compressed air energy storage or compressed fluid energy storage, as depicted in FIG. 4. If such storage is used, the generator size may be reduced because the energy release can be controlled to avoid power spikes, yielding a more levelized energy output. Moreover, the use of a hydraulic transmission as mentioned above may allow for the use of a constant speed generator which removes the need for power electronic converters and improves efficiency. Furthermore, the components and control of the hydraulic system may include a variable displacement motor and synchronous generator or a variable displacement pump and hydraulic accumulator. With a variable pump and variable motor, two closed loop control systems may track optimal tip-speed-ratio and also meet synchronous generator requirements. Various methods for application and control of energy storage in the hydraulic transmission may also be incorporated, both to increase energy production and/or smooth energy output. Such methods and systems may involve the use of a hydraulic accumulator which focuses on smoothing fluctuations in power production due to turbulence or a pumped hydro storage system.

As to the generation of a super-rated power in Region 3, termed Region 3+, which leads to the generation of significantly more power than a conventional turbine, this may be done through manipulation of the rotor via the appropriate manipulation of the rotor's speed, pitch, and/or torque. Specifically, by decreasing the blade pitch angle of all blades on the rotor of the turbine, the aerodynamic power in Region 3+ may be greater than that of Region 3. The decrease in blade pitch angle allows the rotor to generate more power (the super-rated power in the Region 3+) than the rated power limit of a generator. This altered region, named Region 3+, has a control architecture that could be utilized by turbine systems that incorporate any energy storage systems, including the energy storage systems mentioned above and associated with either FIG. 3 and/or FIG. 4. In Region 3+, part of the aerodynamically generated power may be converted to electrical power by the generator and part of the power may be stored for later transmission to the electrical grid. As such, the super-rated power produced in Region 3+ may be produced above the rated power limit of the generator. Instead of constraining the power as is done in conventional Region 3 control, the rotor will be load-limited in Region 3+. The system and related method may switch back to conventional Region 3 once an energy storage capacity level is met. In some embodiment, for example, the energy storage capacity level may be a maximum energy storage capacity.

Additional energy from Region 3+ may be recovered under certain circumstances based on the architecture of Region 3+. The concept of super rating allows a substantially different control architecture for wind speeds above the rated wind speed since the power electronics are no longer the limiting constraint. Herein, the control Region 3+ of the present disclosure, may utilize rotor thrust loads (or the related blade downwind bending moments) as the limiting constraints for power extraction. The peak bending moment conventionally occurs at rated condition and is often a design driver for blade structural design and controller design. A limit based on root Out-of-Plane (OoP) bending moment, the downwind blade bending moment, is a reasonable constraint because it is often directly related to ultimate blade loads and tower clearance. Using this limit, the resulting Region 3+ operational relations for thrust, out-of-plane moment, and power are:

$$T = {T}_{rated} for {U}_{rated} < U < {U}_{cut - out} \qquad ( 4 a )$$

$$M = {M}_{rated} for {U}_{rated} < U < {U}_{cut - out} \qquad ( 4 b )$$

$$P = {T}_{rated} U ( 1 - a ) for {U}_{rated} < U < {U}_{cut - out} \qquad ( 4 c )$$

Herein, “super-rated” operation will refer to operation in Region 3+ with the rotor thrust held constant. However, other options for Region 3+ may include limits based on maximum downwind blade/tower bending moments (including gravity and turbulence effects), damage equivalent loads, and/or resistance to gust loads.

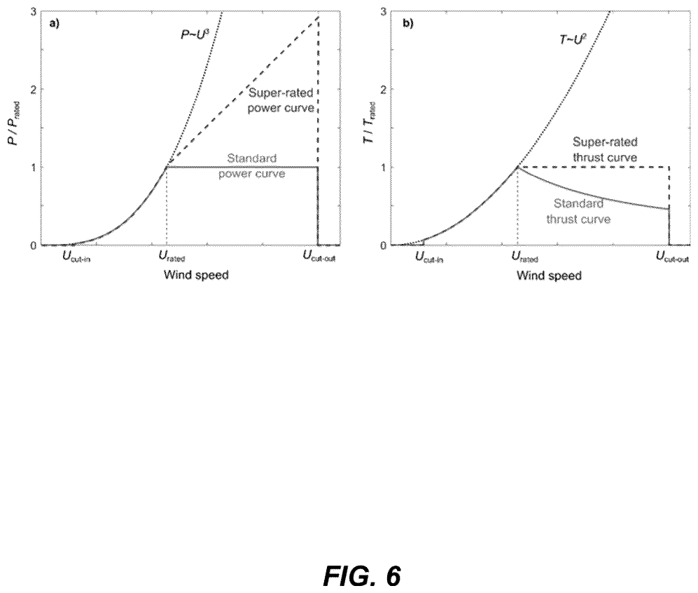

The conventional and proposed operational regimes for thrust and power are shown in FIG. 6. In the conventional power-limited Region 3 control, the thrust loads (and thus, root out-of-plane aerodynamic bending loads) decrease as wind speed increases; while the super-rated control has constant thrust in Region 3+. In both cases, pitch control can be used to set power or shed load.

Since the blade root OoP bending moment and thrust are set to be constant in Region 3+ for super-rated operation, many of the design-driving loads on the turbine and tower remain the same, despite the additional power capture. For example, thrust is the main driving load for tower bending moments, and thus the maximum load will not be increased. However, as power capture increases, rotor torque increases and in-plane root bending moments increase.

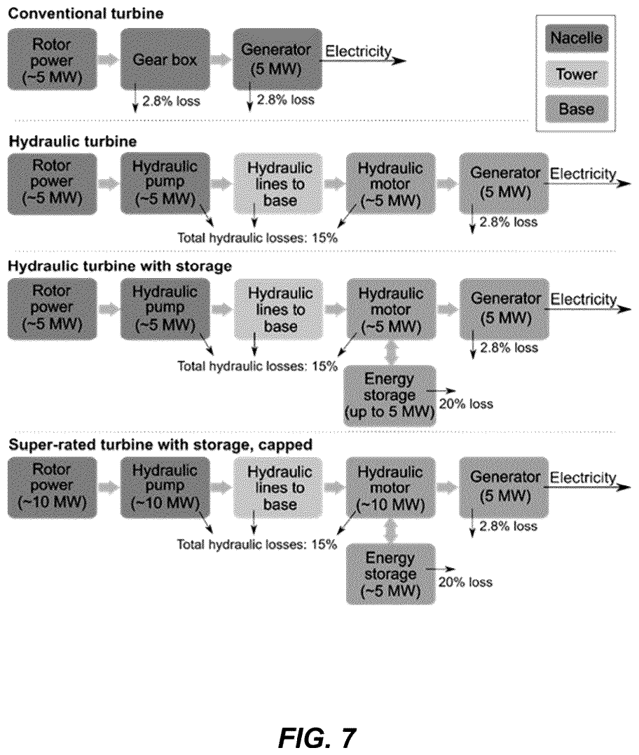

FIG. 7 illustrates a wind turbine configuration for various wind turbine systems, including the “Super-rated turbine with storage, capped” of the present disclosure. The flow of power is depicted from the wind turbine rotor to electricity generated to the electric grid. Note that the conventional wind turbine locates the gearbox and the generator in the nacelle whereas the wind turbine systems that incorporate hydraulic energy storage systems may eliminate the gear box and move the heavy generator to the base of the turbine, thereby drastically reducing capital expenses. Though FIG. 7 shows hydraulic losses associated with the wind turbine systems that incorporate hydraulic energy storage systems, such losses are offset by the reduction in capital expenses more clearly shown in FIG. 5, wherein the reduction in capital cost is almost 25%. Moreover, the “Super-rated turbine with storage, capped” of the present disclosure incorporates the hydraulic system as a mechanical energy storage system. Such incorporation of the “Super-rated turbine with storage, capped” of the present disclosure with the hydraulic system allows for the storage of the super-rated power produced in Region 3+, if needed.

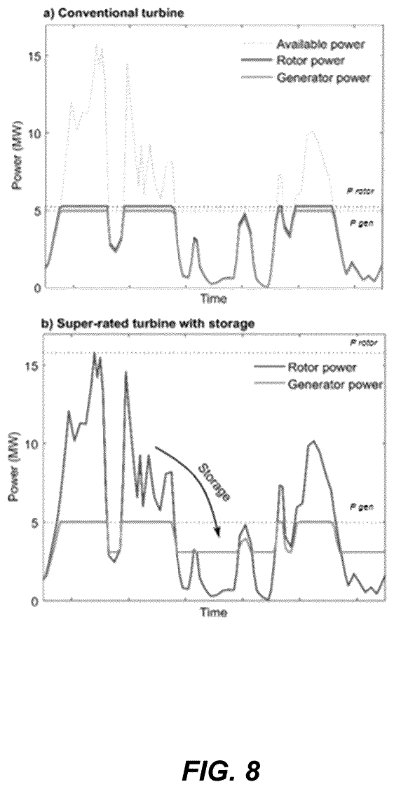

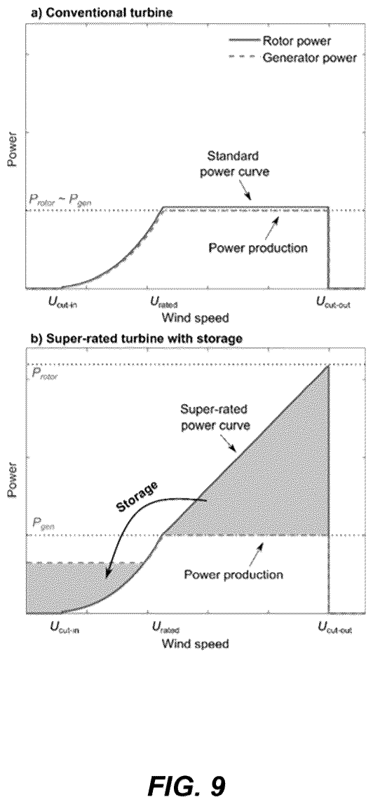

To illustrate the super-rated concept, two modes of operation are shown in FIG. 8 for a notional power variation in time and then repeated in FIG. 9 for a power curve based on wind speed. FIGS. 8a and 9a show operation for a conventional wind turbine. FIGS. 8b and 9b show operation for operation for a hydraulic wind turbine with the super-rated operation for Region 3+, based on the super-rated power and thrust curves of FIG. 6.

FIG. 8 shows the time-dependent aspect of this super-rated operation of the present disclosure compared to conventional turbine operation for variable inflow wind speed over time. For conventional operation of FIG. 8a, the generator power produced is capped by the generator size. The rotor power (Pᵣₒₜₒᵣ) is higher than generator power (P_{gen}) due to drivetrain losses as illustrated in FIG. 7. For the super-rated concept (FIG. 8b) of the present disclosure, the rotor power may be allowed to increase until it reaches a set limit and specifically the rated thrust limit, allowing for additional energy above the generator rated power to be stored in of the aforementioned energy storage systems. The stored energy can be regenerated during periods of low production, which increases the average power produced by the turbine or the wind turbine.

In FIG. 9, power curves are shown for conventional and super-rated turbines. In FIG. 9a, generator and rotor power are nearly equal, while in FIG. 9b, according to an embodiment of the present disclosure, generator and rotor power are significantly different. Energy generated in Region 3+ in excess of the generator limit is stored and regenerated in any of the aforementioned energy storage systems in times of low wind energy, such as Regions 1 and 2. The increased overall power with the super-rated operation (Region 3+) is much more likely to offset the round-trip storage losses and cost of the storage system than integrating storage with conventional wind turbine operation. Thus, unlike a conventional energy storage integration, super-rating, according to an embodiment of the present disclosure, may result in a turbine that will generate more power (rather than less power) without requiring any increase in the wind resource nor in the size of the rotor. In addition, super-rating still provides an opportunity for levelizing the generated power (as seen in FIG. 9b) and could be used to reduce generator size.

Given the increased production of super-rated power, according to an embodiment of the present disclosure, such a system may require a larger size for the hydraulic pump of the hydraulic system shown in each of FIG. 4 and FIG. 7 as the capacity of the energy storage must increase with the rotor power when compared to that of conventional storage integration. As seen in FIG. 7, this will mean that the hydraulic pump may need to be around three times the power at rated wind speeds to handle the winds near cut-out, even though that wind speed regime is highly infrequent at most wind sites. As such, the “Super-rated, capped” system is proposed wherein the hydraulic pump rating is limited to a lower value (e.g., twice the power at rated wind speed) to keep costs down with only a small reduction in average generated power, see FIG. 7.

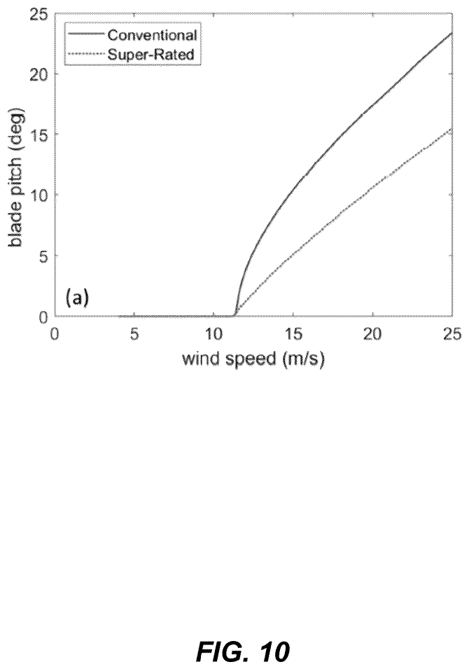

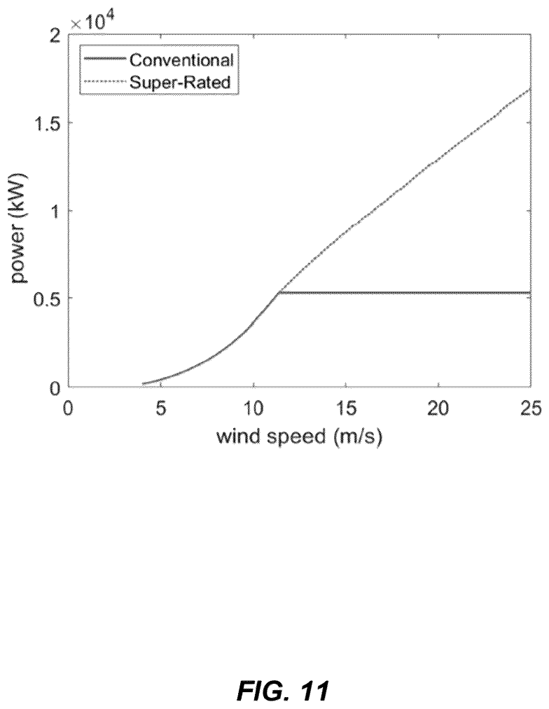

To increase the rotor power and thereby arrive at the super-rated power, the rotor pitch may be lowered while the rotor speed is kept constant, and the rotor torque increases. As can be seen in FIG. 10, the super-rated operation in Region 3+, according to an embodiment of the present disclosure, may have a lower pitch than the conventional operation in Region 3, resulting in the increased power capture seen in FIG. 11 for the super-rated operation. Note, however, that the rotor speed of the wind turbine need not remain constant to achieve the super-rated power.

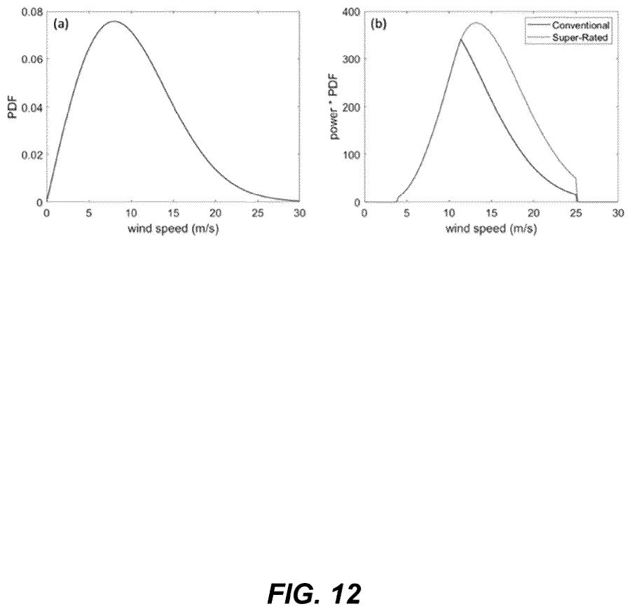

The amount of power that a wind turbine may generate is based on the wind speed distribution at the site where it is located. FIG. 12 illustrates such a wind speed probability distribution function in FIG. 12a. As seen in FIG. 12b, the average power generated at a given wind speed weighted by the probability of the wind speed is the integrated area under the weighted power curves of FIG. 12b. It has been calculated, based on FIG. 12b, that according to an embodiment of the present disclosure, the average power generated for the super-rated wind turbine is 44.5% higher than the average power for the conventional wind turbine.

The system and method of super-rating described herein increases wind turbine power production without increasing rotor diameter or generator size. As mentioned above, super-rated operation entails increasing the allowable torque on the rotor and lowering the rotor pitch in Region 3 to produce additional power above the rated generator power and storing that power for later regeneration in any of the aforementioned energy storage systems mentioned above

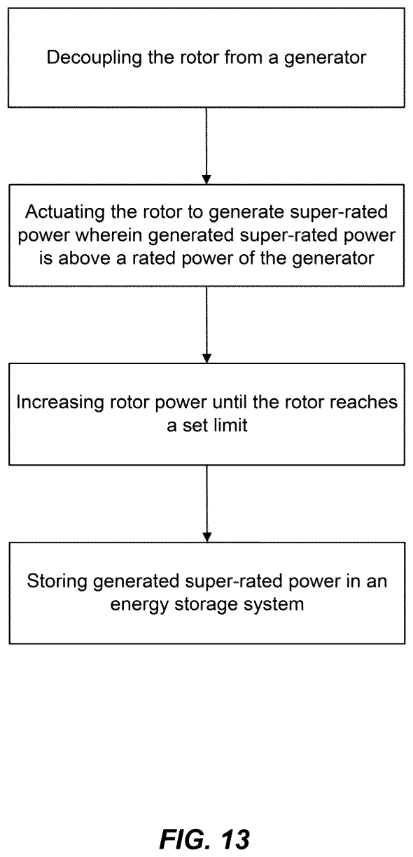

As illustrated in FIG. 13, the method for controlling a turbine having a rotor comprises the steps of decoupling the rotor from a generator, actuating the rotor to generate a super-rated power wherein the super-rated power is above a rated power limit of the generator, increasing rotor power until the rotor reaches a set limit and specifically a rated thrust limit, and storing the super-rated power in an energy storage system. The actuating the rotor step of the method may further comprise one or more of the following steps: keeping the rotor speed constant, lowering the rotor pitch, and/or increasing the rotor torque. Moreover, the method as a whole may further comprise, after storing the super-rated power in an energy storage system, a step of regenerating the super-rated power stored in the energy storage system by coupling the energy storage system to the generator. The regenerating may occur during a period of lower power production so as to increase overall average power production.

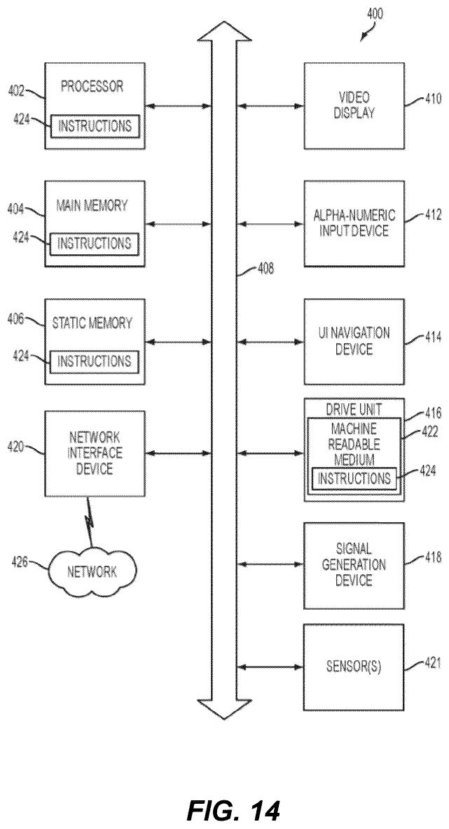

FIG. 14 is a block diagram illustrating an example of a machine upon which one or more aspects of the embodiments of the present disclosure may be implemented. Referring to FIG. 14, an aspect of an embodiment of the present disclosure includes, but not limited thereto, a system, method, and computer readable medium that provides: super-rated operation for increased wind turbine power with energy storage, which illustrates a block diagram of an example machine 400 upon which one or more embodiments (e.g., discussed methodologies) can be implemented (e.g., run).

The machine 400 may include logic, one or more components, circuits (e.g., modules), or other mechanisms. Circuits are tangible entities configured to perform certain operations. In an example, circuits can be arranged (e.g., internally or with respect to external entities such as other circuits) in a specified manner. In an example, one or more computer systems (e.g., a standalone, client or server computer system) or one or more hardware processors (processors) may be configured by software (e.g., instructions, an application portion, or an application) as a circuit that operates to perform certain operations as described herein. In an example, the software can reside (1) on a non-transitory machine readable medium or (2) in a transmission signal. In an example, the software, when executed by the underlying hardware of the circuit, causes the circuit to perform the certain operations.

In an example, a circuit may be implemented mechanically or electronically. For example, a circuit may comprise dedicated circuitry or logic that is specifically configured to perform one or more techniques such as discussed above, such as including a special-purpose processor, a field programmable gate array (FPGA) or an application-specific integrated circuit (ASIC). In an example, a circuit may comprise programmable logic (e.g., circuitry, as encompassed within a general-purpose processor or other programmable processor) that may be temporarily configured (e.g., by software) to perform the certain operations. It will be appreciated that the decision to implement a circuit mechanically (e.g., in dedicated and permanently configured circuitry), or in temporarily configured circuitry (e.g., configured by software) may be driven by cost and time considerations.

Accordingly, the term “circuit” is understood to encompass a tangible entity, be that an entity that is physically constructed, permanently configured (e.g., hardwired), or temporarily (e.g., transitorily) configured (e.g., programmed) to operate in a specified manner or to perform specified operations. In an example, given a plurality of temporarily configured circuits, each of the circuits need not be configured or instantiated at any one instance in time. For example, where the circuits comprise a general-purpose processor configured via software, the general-purpose processor may be configured as respective different circuits at different times. Software may accordingly configure a processor, for example, to constitute a particular circuit at one instance of time and to constitute a different circuit at a different instance of time.

In an example, circuits may provide information to, and receive information from, other circuits. In this example, the circuits can be regarded as being communicatively coupled to one or more other circuits. Where multiple of such circuits exist contemporaneously, communications may be achieved through signal transmission (e.g., over appropriate circuits and buses) that connect the circuits. In embodiments in which multiple circuits are configured or instantiated at different times, communications between such circuits may be achieved, for example, through the storage and retrieval of information in memory structures to which the multiple circuits have access. For example, one circuit may perform an operation and store the output of that operation in a memory device to which it is communicatively coupled. A further circuit may then, at a later time, access the memory device to retrieve and process the stored output. In an example, circuits may be configured to initiate or receive communications with input or output devices and may operate on a resource (e.g., a collection of information).

The various operations of method examples described herein may be performed, at least partially, by one or more processors that are temporarily configured (e.g., by software) or permanently configured to perform the relevant operations. Whether temporarily or permanently configured, such processors may constitute processor-implemented circuits that operate to perform one or more operations or functions. In an example, the circuits referred to herein can comprise processor-implemented circuits.

Similarly, the methods described herein may be at least partially processor implemented. For example, at least some of the operations of a method may be performed by one or processors or processor-implemented circuits. The performance of certain of the operations may be distributed among the one or more processors, not only residing within a single machine, but deployed across a number of machines. In an example, the processor or processors may be located in a single location (e.g., within a home environment, an office environment or as a server farm), while in other examples the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., Application Program Interfaces (APIs).)

Example embodiments (e.g., apparatus, systems, or methods) may be implemented in digital electronic circuitry, in computer hardware, in firmware, in software, or in any combination thereof. Example embodiments may be implemented using a computer program product (e.g., a computer program, tangibly embodied in an information carrier or in a machine readable medium, for execution by, or to control the operation of, data processing apparatus such as a programmable processor, a computer, or multiple computers).

A computer program may be written in any form of programming language, including compiled or interpreted languages, and it may be deployed in any form, including as a stand-alone program or as a software module, subroutine, or other unit suitable for use in a computing environment. A computer program may be deployed to be executed on one computer or on multiple computers at one site or distributed across multiple sites and interconnected by a communication network.

In an example, operations may be performed by one or more programmable processors executing a computer program to perform functions by operating on input data and generating output. Examples of method operations may also be performed by, and example apparatus can be implemented as, special purpose logic circuitry (e.g., a field programmable gate array (FPGA) or an application-specific integrated circuit (ASIC)).

The computing system may include clients and servers. A client and server are generally remote from each other and generally interact through a communication network. The relationship of client and server arises by virtue of computer programs running on the respective computers and having a client-server relationship to each other. In embodiments deploying a programmable computing system, it will be appreciated that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware can be a design choice. Below are set out hardware (e.g., machine 400) and software architectures that can be deployed in example embodiments.

In an example, the machine 400 may operate as a standalone device or the machine 400 may be connected (e.g., networked) to other machines.

In a networked deployment, the machine 400 may operate in the capacity of either a server or a client machine in server-client network environments. In an example, the machine 400 can act as a peer machine in peer-to-peer (or other distributed) network environments. The machine 400 may be a personal computer (PC), a tablet PC, a set-top box (STB), a Personal Digital Assistant (PDA), a mobile telephone, a web appliance, a network router, switch or bridge, or any machine capable of executing instructions (sequential or otherwise) specifying actions to be taken (e.g., performed) by the machine 400. Further, while only a single machine 400 is illustrated, the term “machine” shall also be taken to include any collection of machines that individually or jointly execute a set (or multiple sets) of instructions to perform any one or more of the methodologies discussed herein.

As seen in FIG. 14, example machine (e.g., computer system) 400 may include a processor 402 (e.g., a central processing unit (CPU), a graphics processing unit (GPU) or both), a main memory 404 and a static memory 406, some or all of which can communicate with each other via a bus 408. The machine 400 may further include a display unit 410, an alphanumeric input device 412 (e.g., a keyboard), and a user interface (UI) navigation device 411 (e.g., a mouse). In an example, the display unit 810, input device 417 and UI navigation device 414 may be a touch screen display. The machine 400 may additionally include a storage device (e.g., drive unit) 416, a signal generation device 418 (e.g., a speaker), a network interface device 420, and one or more sensors 421, such as a global positioning system (GPS) sensor, compass, accelerometer, or other sensor.

The storage device 416 may include a machine readable medium 422 on which is stored one or more sets of data structures or instructions 424 (e.g., software) embodying or utilized by any one or more of the methodologies or functions described herein. The instructions 424 may also reside, completely or at least partially, within the main memory 404, within static memory 406, or within the processor 402 during execution thereof by the machine 400. In an example, one or any combination of the processor 402, the main memory 404, the static memory 406, or the storage device 416 may constitute machine readable media.

While the machine readable medium 422 is illustrated as a single medium, the term “machine readable medium” may include a single medium or multiple media (e.g., a centralized or distributed database, and/or associated caches and servers) configured to store the one or more instructions 424. The term “machine readable medium” may also be taken to include any tangible medium that is capable of storing, encoding, or carrying instructions for execution by the machine and that cause the machine to perform any one or more of the methodologies of the present disclosure or that is capable of storing, encoding or carrying data structures utilized by or associated with such instructions. The term “machine readable medium” may accordingly be taken to include, but not be limited to, solid-state memories, and optical and magnetic media. Specific examples of machine-readable media may include non-volatile memory, including, by way of example, semiconductor memory devices (e.g., Electrically Programmable Read Only Memory (EPROM), Electrically Erasable Programmable Read-Only Memory (EEPROM)) and flash memory devices; magnetic disks such as internal hard disks and removable disks; magneto-optical disks; and CD-ROM and DVDROM disks.

The instructions 424 may further be transmitted or received over a communications network 426 using a transmission medium via the network interface device 420 utilizing any one of a number of transfer protocols (e.g., frame relay, IP, TCP, UDP, HTTP, etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., IEEE 802.11 standards family known as Wi-Fi®, IEEE 802.16 standards family known as WiMax®), peer-to-peer (P2P) networks, among others. The term “transmission medium” shall be taken to include any intangible medium that is capable of storing, encoding or carrying instructions for execution by the machine, and includes digital or analog communications signals or other intangible medium to facilitate communication of such software.

It will be apparent to persons skilled in the art that various modifications and variations can be made to the disclosed structure. While illustrative embodiments have been described herein, the scope of the present invention includes any and all embodiments having equivalent elements, modifications, omissions, combinations (e.g., of aspects across various embodiments), adaptations and/or alterations as would be appreciated by those skilled in the art based on the present invention. The limitations in the claims are to be interpreted broadly based on the language employed in the claims and not limited to examples described in the present specification or during the prosecution of the application, which examples are to be construed as non-exclusive. Further, the steps of the disclosed methods may be modified in any manner, including by reordering steps and/or inserting or deleting steps, without departing from the principles of the present invention. It is intended, therefore, that the specification and examples be considered as exemplary only, with a true scope and spirit of the present invention being indicated by the following claims and their full scope of equivalents.

What is claimed is:

1. A system for increasing power capture, comprising:
a turbine having a rotor;
a generator having a rated power limit; and
an energy storage system; wherein,
the rotor generates super-rated power above the rated power limit of the generator and generated super-rated power is stored in the energy storage system before the generator converts generated super-rated power into electric power.

2. The system of claim 1, wherein all generated super-rated power is stored in the energy storage system before the generator converts generated super-rated power into electric power.

3. The system of claim 1, wherein during operation the rotor has a speed, a pitch, and a torque.

4. The system of claim 1, wherein the energy storage system includes one or more of a battery storage system, a liquid metal battery storage system, or a mechanical energy storage system.

5. The system of claim 4, further comprising a tower, wherein the turbine is a wind turbine that is situated on the tower and the generator is situated at a base of the tower.

6. The system of claim 5, wherein the mechanical energy storage system is at least one of a hydraulic system, a hydraulic accumulator system, a flywheel system, a pumped hydro storage system, or a compressed air energy storage system.

7. The system of claim 6, wherein the hydraulic system comprises a hydraulic compressor, hydraulic hoses, and a variable hydraulic motor.

8. The system of claim 7, wherein generated super-rated power is delivered to the hydraulic compressor which generates hydraulic power that is transmitted by the hydraulic hoses down to the base of the tower to the variable hydraulic motor.

9. The system of claim 8, wherein the variable hydraulic motor either creates mechanical energy storage or converts the hydraulic power into electric power through the generator.

10. The system of claim 9, wherein the mechanical energy storage is in the form of compressed fluid energy storage.

11. A wind turbine comprising:
a tower with a base;
a rotor;
a generator having a rated power limit; and
an energy storage system; wherein,
the wind turbine is situated on the tower and the generator is situated at the base of the tower.

12. The wind turbine of claim 11, wherein the rotor generates super-rated power above a rated power limit of the generator.

13. The wind turbine of claim 12, wherein generated super-rated power is stored in the energy storage system before the generator converts the super-rated power into electric power.

14. A method of controlling a turbine having a rotor, the method comprising the steps of:
decoupling the rotor from a generator,
actuating the rotor to generate super-rated power wherein generated super-rated power is above a rated power limit of the generator,
increasing rotor power until the rotor reaches a set limit, and storing generated super-rated power in an energy storage system.

15. The method of claim 14, wherein decoupling the rotor from the generator further comprises the use of a hydraulic transmission to decouple the rotor from the generator.

16. The method of claim 14, wherein storing generated super-rated power in an energy storage system further comprises storing generated super-rated power in a hydraulic energy storage system.

17. The method of claim 14, wherein actuating the rotor to generate super-rated power further comprises:
keeping the rotor speed constant,
lowering the rotor pitch, and
increasing the rotor torque.

18. The method of claim 14, wherein storing generated super-rated power in an energy storage system further comprises storing generated super-rated power in one or more of a battery energy storage system, a liquid metal battery energy storage system, or a mechanical energy storage system.

19. The method of claim 14, further comprising:
regenerating generated super-rated power stored in the energy storage system by coupling the energy storage system to the generator.

20. The method of claim 19, further comprising:
regenerating generated super-rated power during a period of lower power production.
